(19) United States
(12) Patent Application Publication
(10) Pub. No.: US 2016/0278034 A1
(43) Pub. Date: Sep. 22, 2016

(54) Clock System and Method for Time Synchronization

(71) Applicant: Electronics Tomorrow Limited, Hong Kong (HK)

(72) Inventors: Chun Kit Edmund WATT, Hong Kong (HK); Andrew Yick Siu WEI, Hong Kong (HK)

(73) Assignee: Electronics Tomorrow Limited

(21) Appl. No.: 15/072,113

(22) Filed: Mar. 16, 2016

(30) Foreign Application Priority Data
Mar. 16, 2015 (JP) 2015-052648

(51) Int. Cl. H04W 56/00; H04W 24/10; H04L 5/00

(52) U.S. Cl. CPC H04W 56/0015; H04L 5/0048; H04W 24/10

(57) ABSTRACT

A clock system is provided which is capable of synchronizing times of a plurality of units in a system. In a clock system (1) including a plurality of units (10), each of the plurality of units (10) executes: receiving a radio signal; acquiring, from a received radio signal, time data including information on a time, and correcting a time of a clocking unit (106) based on time information included in the time data; displaying a time of the clocking unit (106); and transmitting time data including information on a time clocked by the clocking unit (106) and including a level that indicates how many units (10) the obtained time has passed through, thereby synchronizing times of the plurality of units (10).

### CROSS-REFERENCES TO RELATED APPLICATIONS

This application is based on Japanese Patent Application No. 2015-052648, filed on Mar. 16, 2015, the entire disclosure of which is incorporated herein by reference.

### BACKGROUND

1. Field

The present disclosure relates to a clock system and a time synchronization method.

2. Description of Related Art

Conventionally, a master-slave clock apparatus which transmits information on a time clocked by a master clock and then synchronizes the time clocked by a slave clock that has received such time information with the time clocked by the master clock is known. For instance, Patent Document 1 discloses a master-slave clock apparatus in which a master clock causes the time clocked by a slave clock to be synchronized with the time clocked by the master clock, via an existing signal line, by way of two types of synchronization methods, that is, a time signal and a time code signal, whereby, even if the time clocked by the slave clock is different from that of the master clock, such times can be synchronized easily.

Patent Document 1: JP2002-040173 A

Patent Document 2: JP2002-148371 A

### SUMMARY

The master-slave clock apparatus disclosed in Patent Document 1 transmits and receives time information using a cable, etc., and further, the slave clock needs to directly receive time information from the master clock in order to synchronize a time of the slave clock with a time of the master clock, and this puts limitations on the positions where the master clock and the slave clock are provided.

In order to eliminate such limitations, Patent Document 2 discloses a radio master-slave clock system in which a master clock wirelessly, such as through radio waves, transmits time information serving as a reference, and in which slave clocks arranged around the master clock each receive such time information, so that a time of each slave clock is corrected based on the reference time information of the master clock so as to match the time of the master clock. Further, in the master-slave clock system disclosed in Patent Document 2, time correction is performed in a relay system from a slave clock that has received time information of the master clock to another slave clock, whereby, even when a slave clock is arranged at a position where such slave clock cannot directly receive time information from the master clock, a time of the slave clock can be corrected. As a result, a plurality of slave clocks can be arranged relatively freely at a site or a location.

Patent Document 2 discloses that it is necessary to take as long as one hour per downlink process for performing time correction between a master clock and slave clocks. That is, the master-slave clock system disclosed in Patent Document 2 has involved a great deal of time consumed for the process of synchronizing times of a plurality of clocks.

In light of the above circumstances, one of the objects of the present disclosure is to provide a clock system that is capable of synchronizing times of a plurality of units in the clock system within a period shorter than that required in the prior art. Other objects of the present disclosure will be apparent by referring to the specification in its entirety.

A unit according to an embodiment of the present disclosure comprises: a receiver which receives a radio signal; a clocking unit which clocks a time; a time correcting part which acquires, from the radio signal received by the receiver, time data including information on a time, and corrects a time of the clocking unit based on time information included in the time data; a display unit for displaying a time of the clocking unit; and a transmitter which transmits time data including information on a time clocked by the clocking unit and including a level that indicates how many units the obtained time has passed through.

Preferably, the unit further comprises a level holding part which holds, as a level of the unit, a level obtained by adding 1 to a level included in time data that has been taken out of the radio signal received by the receiver, and a level included in time data transmitted by the transmitter is based on a level held by the level holding part.

Preferably, when a plurality of time data is taken out of a plurality of radio signals, the receiver identifies a time slot which involves a minimum level included in time data, and when there is a plurality of time data each having a minimum level, identifies a time slot which involves a signal having a strongest strength with regard to the plurality of data, and the time correcting part corrects a time of the clocking unit based on time data acquired from the identified time slot.

Preferably, the transmitter examines a radio signal received by the receiver so as to pick an empty time slot and transmits the time data using the picked empty time slot.

A clock system according to an embodiment of the present disclosure is configured by including a plurality of the above-described units. It is preferable for at least one of the plurality of units to operate as a master and for the master to acquire information on a current time from outside of the clock system and to correct a time of the clocking unit.

A time synchronization method according to an embodiment of the present disclosure is a method executed, in a clock system including a plurality of units, by each of the plurality of units. Each unit executes: receiving a radio signal; acquiring, from the received radio signal, time data including information on a time, and correcting a time of a clocking unit based on time information included in the time data; displaying a time of the clocking unit; and transmitting time data including information on a time clocked by the clocking unit and including a level that indicates how many units the obtained time has passed through, thereby synchronizing times of the plurality of units.

The clock system and the time synchronization method of the present disclosure may allow for the synchronization of times of a plurality of units in a clock system for a period shorter than that required in the prior art.

### BRIEF DESCRIPTION OF DRAWINGS

The above object and other objects of the present disclosure, as well as the characteristics and advantages thereof, will be more apparent from the detailed descriptions below with reference to the accompanying drawings.

FIG. 1 is a schematic diagram showing an example of an overall configuration of a clock system 1 according to an embodiment of the present invention.

FIG. 2 is a schematic diagram showing a functional configuration of units 10, namely, a master 11 and repeaters 12, according to the present embodiment.

FIG. 3 is a diagram showing an example of an outline of time slots in the present embodiment.

FIG. 4 is a diagram showing an example of a structure of time data transmitted by a unit 10 in the present embodiment.

FIG. 5 is a flowchart showing an outline of a processing protocol in the present embodiment.

### DETAILED DESCRIPTION

Embodiments of the present invention will be described below in detail with reference to the drawings. The embodiments set forth below are illustrative in order to describe the present invention and are not intended to limit the present invention thereto. Further, various modifications of the present invention can be made unless such variations depart from the gist of the present invention.

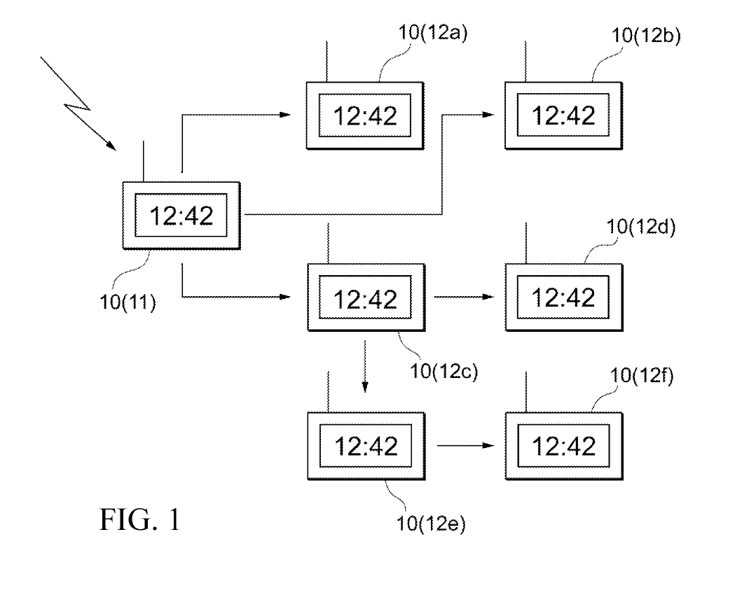

FIG. 1 is a schematic diagram showing an example of an overall configuration of a clock system 1 according to an embodiment of the present invention. As shown in the same figure, in the present embodiment, the clock system 1 is configured by comprising a plurality of units (clock units) 10 (11 and 12). At least one of the plurality of units 10 operates as a master 11, and the remaining units 10 operate as repeaters 12 (12a, 12b, . . . ). Characters a, b, . . . each of which are attached to the reference symbol 12, are used to distinguish a plurality of repeaters, being the same elements, from one another; however, such attached characters will be omitted as appropriate in the descriptions below, for instance, when such repeaters do not need to be distinguished from one another.

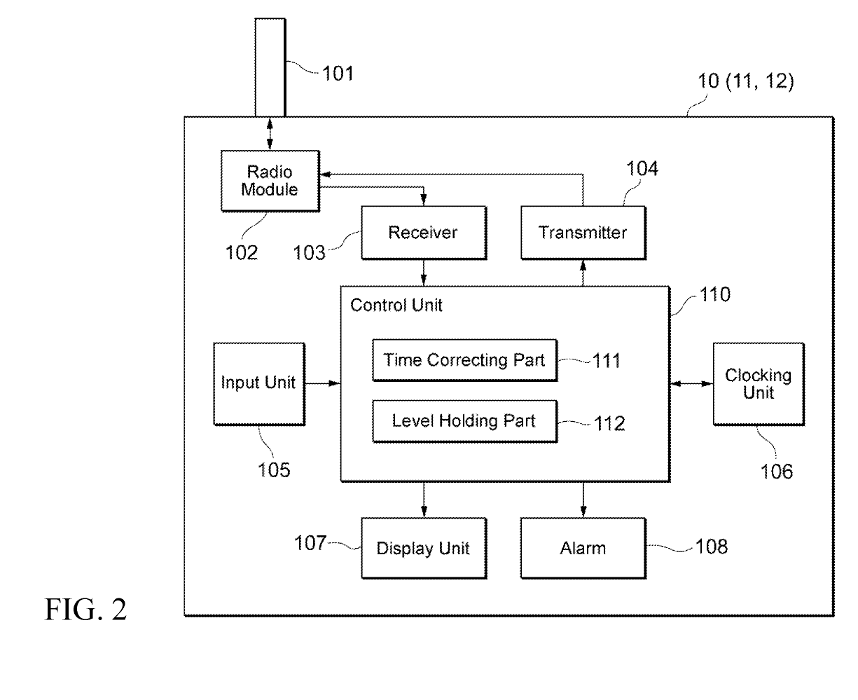

FIG. 2 is a schematic diagram showing a functional configuration of the units 10, namely, the master 11 and the repeaters 12, according to the present embodiment. As shown in the same figure, each of the units 10 includes, for example, an antenna 101, a radio module 102, a receiver 103, a transmitter 104, an input unit 105, a clocking unit 106, a display unit 107, an alarm 108, and a control unit 110. The control unit 110 includes a time correcting part 111 and a level holding part 112.

The antenna 101 is an antenna for transmitting and receiving radio signals. The radio module 102 is a module for handling 2.4 GHz band radio signals and performs, for example, filtering of unnecessary signals.

The receiver 103 receives radio signals via the antenna 101 and the radio module 102. When a unit 10 is used as the master 11, the receiver 103 receives radio waves on standard time information from the outside (broadcast time signals, standard radio waves (JJY), etc.) so as to acquire a standard time as time data. Such acquisition of a standard time in the master 11 can be attained not only by way of standard radio waves, but also by way of other various time information sources, such as GPS (Global Positioning System) radio waves, network time protocol (NTP) and the acquisition of time information of a smartphone via Bluetooth (registered trademark). When a unit 10 is used as one of the repeaters 12, the receiver 103 receives radio signals transmitted from the master 11 or another repeater 12 so as to acquire time data.

The transmitter 104 configures time data including time information clocked by the clocking unit 106 and also including a level held by the level holding part 112, and uses an empty time slot so as to transmit such time data via the radio module 102 and the antenna 101.

The input unit 105 is configured by a user interface, such as a button or a touch panel, for inputting information on a time. The master 11 may acquire a standard time based on information input from the input unit 105, rather than receiving standard radio waves.

The clocking unit 106 is a configuration for clocking a time. The display unit 107 is a configuration for displaying a time of the clocking unit 106. The alarm 108 is a configuration for outputting an alarm based on a time of the clocking unit 106.

The control unit 110 is configured by a processor, etc., and is intended to control operations of the receiver 103, the transmitter 104, the input unit 105, the clocking unit 106, the display unit 107 and the alarm 108. For instance, the control unit 110 performs control such that the display unit 107 displays a current time based on time information of the clocking unit 106. “Display”-ing a time encompasses not only a feature in which a time is displayed in a so-called digital clock manner on a display apparatus, such as a liquid crystal display, but also a feature in which a time is displayed in a so-called analog clock manner using hands which indicate hours, minutes and seconds.

Upon acquisition of time data including information on a time (time information) from radio signals received by the receiver 103, the time correcting part 111 corrects a time of the clocking unit 106 based on the time information included in such time data so as to synchronize such time with the time information included in such acquired time data.

The level holding part 112 is a configuration for holding information on a level that indicates how many units 10 an obtained time of the clocking unit 106 has passed through. When a unit 10 is used as the master 11, the level holding part 112 holds level “1.” When a unit 10 is used as the repeater 12, the level holding part 112 holds, as a level of such repeater 12, a level obtained by adding 1 to the level included in the time data which has been taken out of radio signals received by the receiver 103.

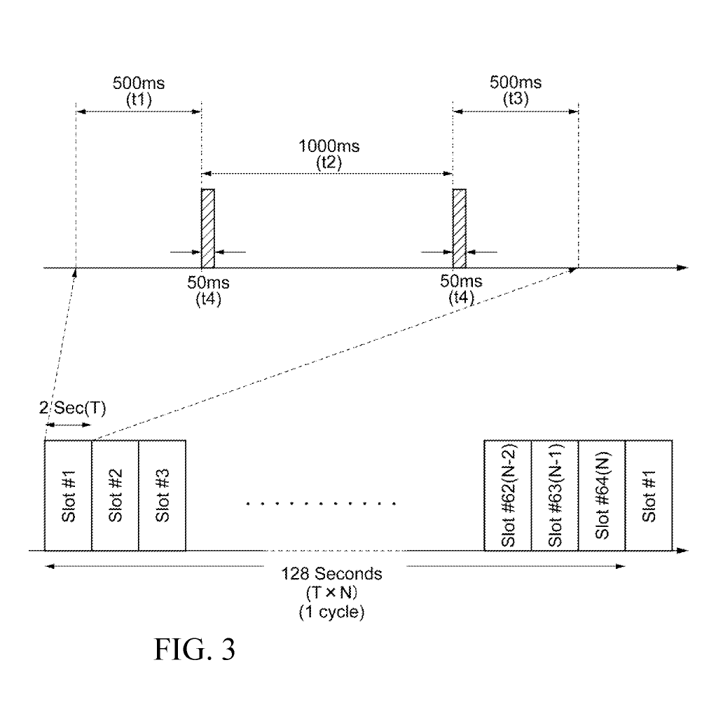

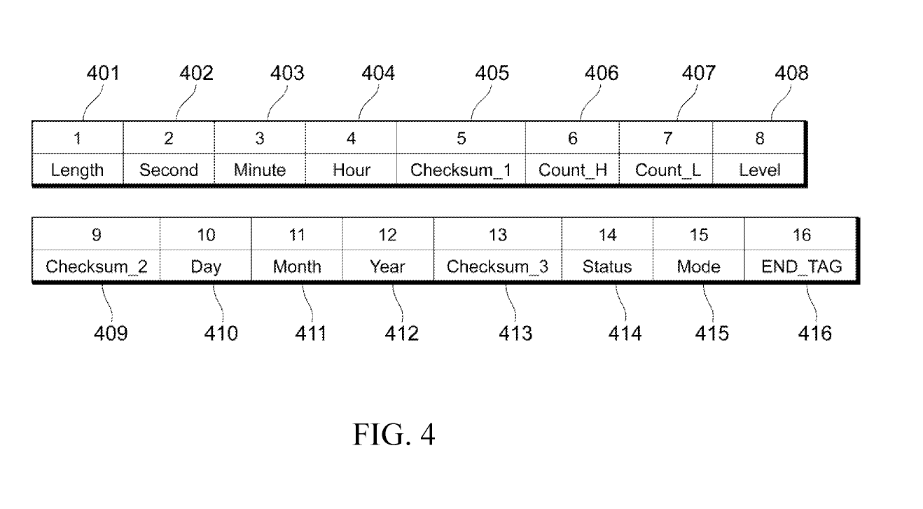

A processing protocol which is carried out by each unit 10 in the present embodiment will be described below with reference to FIGS. 3 and 4.

In the present embodiment, the transmission and receipt of time data in the clock system 1 is assumed to be performed by time-division multiplexing. More specifically, a period is divided into fixed-time cycles, and each of the cycles is further divided into a plurality of time slots. Each of the units 10 (the master 11 and the repeaters 12) transmits time data, using the time slot at the same position in each cycle, whereby times of the units 10 in the clock system 1 are synchronized.

FIG. 3 is a diagram showing an example of an outline of time slots in the present embodiment. As shown in the same figure, one time slot is assumed to have a time width of two seconds, and the number of time slots in one cycle is assumed to be 64. However, the time width of a time slot and the number of time slots per cycle are not to limited to those mentioned above and can be set arbitrarily. That is, the time width of a time slot is not limited to 2 seconds and can be generalized as T seconds.

Further, the number of time slots per cycle is not fixed at 64 and can be generalized as N. N is any natural number. The number of time slots is flexibly variable in accordance with the usage. For instance, when the number of time slots is 16, clocks can be synchronized more quickly than in the case of 64 time slots. Further, when the number of time slots is 128, the number of units 10 which can be synchronized in the clock system 1 can be greater than that in the case of 64 time slots. The period of one cycle is a period obtained by multiplying the time width of a time slot by the number of time slots per cycle, and therefore, in the embodiment shown in FIG. 4, one cycle is equal to 128 seconds. The period of one cycle can be generalized as T×N seconds.

As described above, each unit 10 transmits time data, using the time slot at the same position every time, in each cycle. In such circumstances, the unit 10 transmits time data twice in one time slot. For instance, in the example shown in FIG. 3, at the time point after 0.5 seconds (500 msec) from the start of a time slot, first time data (first data packet) is transmitted for 50 msec, and then after one second (1,000 msec), i.e., at the time point of 1.5 seconds after the start of the time slot, second time data (second data packet) is transmitted for 50 msec again.

Time points when time data is transmitted, and also the time-data transmission period, are not limited to those set forth in the example of FIG. 4, and can be changed arbitrarily. For instance, times points when time data is transmitted can be set such that: at the time point after t1 seconds from the start of a time slot, first time data is transmitted for t4 seconds; after t2 seconds from the start of the transmission of the first time data, second time data is transmitted for t4 seconds; and after t3 seconds from the start of the transmission of the second time data, the time slot is completed. In such circumstances, the condition t1+t2+t3=T needs to be satisfied. t1, t2 and t3 may each be any value, and for example, the values under the equation t1=t3=T/4 may be employed. Further, the period t4 during which time data is transmitted is preferably determined depending on the length of a data packet; however, the period t4 is not limited to such example and can be set arbitrarily. Moreover, the number of times when time data is transmitted in one time slot is not limited to two, and time data may also be transmitted once or an arbitrary number of times.

When time data is transmitted a plurality of times in one time slot, the interval between transmissions of time data is preferably adjusted so as to have value equal to or greater than a predetermined value, depending on the frequency of transmitted signals. In general, it often happens that a device which uses the 2.4 GHz band does not occupy the same frequency channel for 0.4 seconds or longer. Therefore, the interval between transmissions of time data is set so as to be longer than 0.4 seconds, thereby preventing two transmission signals transmitted in one time slot from being interfered with by another device which uses the 2.4 GHz band. An effective transmission distance corresponds to, for example, a straight line of approximately 200 meters.

FIG. 4 is a diagram showing an example of a structure of time data transmitted by the unit 10 in the present embodiment. In the present embodiment, time data is shown as being configured by a 16-byte data packet. However, the data length of time data, the data structure thereof and the data order thereof are not limited to those illustrated in FIG. 4, and time data can be configured, as appropriate, based on any data length, any data structure and any data order.

A first byte 401 includes information on the total number of bytes of a data packet. A second byte 402 includes information on the “seconds” of the current time information. A third byte 403 includes information on the “minutes” of the current time information. A fourth byte 404 includes information on the “hours” of the current time information. A fifth byte 405 is a checksum of the data included in the second to fourth bytes.

A sixth byte 406 and a seventh byte 407 each include information on a number attached to a time slot during which time data is transmitted. The sixth byte 406 corresponds to the upper byte of a time-slot number, and the seventh byte 407 corresponds to the lower byte thereof. An eighth byte 408 includes information on a level of time data included in a time slot. A ninth byte 409 is a checksum of the data included in the sixth to eighth bytes.

A tenth byte 410 includes information on the “days” of the current time information. An eleventh byte 411 includes information on the “months” of the current time information. A twelfth byte 412 includes information on the “years” of the current time information. A thirteenth byte 413 is a checksum of the data included in the tenth to twelfth bytes.

A fourteenth byte 414 includes information on a status of the unit 10 which has transmitted time data. In such circumstances, status information refers to, for example, information as to which process is performed by the unit 10 that has transmitted time data, from among a signal search process, a lock process, an examination process, a verification process, and a repeater process, which will be described below. A fifteenth byte 415 includes information as to whether time data corresponds to the first data packet of a time slot or the second data packet thereof. A sixteenth byte 416 includes a constant which indicates the end of a packet.

A protocol according to the present embodiment will be described below.

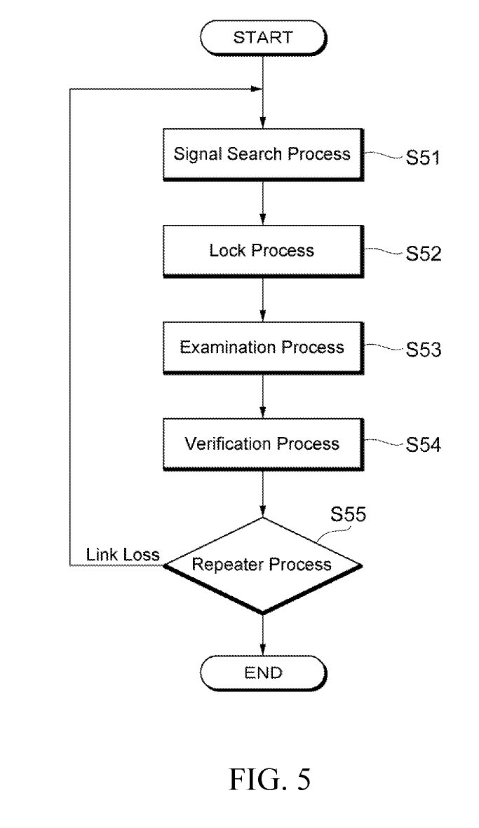

FIG. 5 is a flowchart showing an outline of a processing protocol in the present embodiment. Each unit 10 in the clock system 1 performs processes in accordance with the following protocol.

Firstly, each unit 10 performs a signal search process (step S51). Each unit 10 actuates the receiver 103 so as to receive radio signals in a predetermined band. In the present embodiment, the master 11 receives radio waves on standard time information from the outside. Since time data is transmitted/received, among the units 10 included in the clock system 1, by way of 2.4 gigahertz (GHz) radio signals, each repeater 12 receives 2.4 GHz band radio signals. Further, each unit 10 checks all the time slots included in one cycle, and, from among the 64 time slots in one cycle, searches for a time slot which involves a minimum level included in time data, and when there is a plurality of time data, each including a minimum level, searches for a time slot which involves a radio signal having the strongest strength with regard to such plurality of time data. In this way, each unit 10 identifies a time slot, from among the time slots in one cycle, which involves time data that is expected to have a minimum time delay from a time of the master 11 and that is best in terms of involving a strong signal strength. This signal search process is generally completed in one cycle.

Next, each unit 10 performs a lock process (step S52). The master 11 acquires a standard time from the received standard time information and corrects a time of the clocking unit 106 inside the master 11, based on such acquired standard time. Each repeater 12 reads time data from radio signals involved in the time slot identified by the signal search process and then corrects the time. More specifically, when the time slot identified by the signal search process S51 is approaching, each repeater 12 actuates the receiver 103 so as to receive radio signals involved in such time slot and to read time data. When such reading of time data has been successfully conducted, the time correcting part 111 corrects a time of the clocking unit 106 inside the unit 10, based on such read time data. The control unit 110 then performs control such that the display unit 107 displays a time based on such corrected time. Further, the level holding part 112 of each repeater 12 holds its own level, by, for example, storing, in a memory, a level obtained by adding 1 to the level read from the received time data. The level holding part 112 of the master 11 holds level “1.” This lock process is generally completed in three cycles.

Each unit 10 then performs an examination process on empty time slots (step S53). Each unit 10 actuates the receiver 103 so as to examine which time slots, from among the time slots in one cycle, serve as time slots in use or time slots not in use, i.e., empty time slots. The unit 10 then picks one time slot for the transmission of time data of the unit 10 itself from among such empty time slots. This examination process is generally completed in one cycle.

Each unit 10 then performs a time-slot verification process (step S54). More specifically, for instance, each unit 10 selects any two cycles out of sixteen cycles, and verifies whether or not the time slot picked in the examination process is still unused. During the remaining fourteen cycles, the unit 10 transmits its own time data, using the time slot picked by the examination process. In such circumstances, such transmitted time data is configured based on a time clocked by the clocking unit 106 inside the unit 10 and also based on its own level held by the level holding part 112. It should be noted that, in the verification process, it is possible to arbitrarily set the number of cycles employed for verification into whether or not a time slot is unused and the number of cycles employed for transmission of time data, as well as the combination of such numbers.

Each unit 10 then performs a repeater process on time data (step S55). More specifically, in each cycle, each unit 10 receives time data, using the time slot identified by the signal search process and corrects the time, and then transmits its own time data, using the time slot picked and verified by the examination process and the verification process.

Each unit 10 executes the above processes from steps S51 to S55 for a predetermined period, for example, 12 times a day, that is, every two hours, so as to perform time corrections and the forwarding process.

It should be noted that, if each unit 10 has failed to receive time data in the repeater process of step S55, the unit 10 then performs a recovery process. In the present embodiment, time data is transmitted twice during one time slot; however, if each unit 10 has failed to properly receive time data, for example, when time data has been corrupted or interfered with by other radio waves on two occasions, the unit 10 actuates the receiver 103 again in the next cycle so as to attempt to receive the time data. If each unit 10 still fails to receive the time data even after the lapse of a predetermined number of cycles (for example, three cycles), this is assumed to be a link loss, and the procedure is performed again, starting from the signal search process of step S51. It should be noted that, in the recovery process, the number of cycles for retrying to receive time data can be set arbitrarily.

Next, explanation will be made below regarding how the above-described protocol is carried out based on the system configuration shown in FIG. 1.

Firstly, the master 11 receives radio waves on standard time information from the outside, acquires a standard time and then corrects a time of the clocking unit 106 based on such acquired standard time. The master 11 then picks one empty time slot and transmits time data. For instance, the master 11 transmits level “1” time data, using a first time slot.

In the example shown in FIG. 1, each of the repeaters 12a, 12b and 12c identifies a first time slot as a result of the signal search process and receives time data transmitted from the master 11. As a result, the times of the repeaters 12a, 12b and 12c are synchronized with the time of the master 11. This indicates that, although the repeaters 12a, 12b and 12c may have each received the time data transmitted from another repeater 12, such time data transmitted from the master 11, namely, a data packet included in the first time slot from among the time slots in one cycle, has the minimum level and the strongest radio-signal strength.

Further, the synchronization of each of the repeaters 12a, 12b and 12c is performed based on level “1” time data, and thus, the relevant level holding part 112 holds level “2.” Each of the repeaters 12a, 12b and 12c picks one empty time slot and then transmits time data. For instance, the repeater 12a transmits level “2” time data, using a second time slot. Similarly, the repeaters 12b and 12c transmit level “2” time data, using a third time slot and a fourth time slot, respectively.

In the example shown in FIG. 1, each of the repeaters 12d and 12e identifies a fourth time slot as a result of the signal search process and receives time data transmitted from the repeater 12c. As a result, the times of the repeaters 12d and 12e are synchronized with the time of the repeater 12c. This indicates that, in the repeaters 12d and 12e, the time data transmitted from the repeater 12c, namely, a data packet included in the fourth time slot from among the time slots in one cycle, has the minimum level and the strongest radio-signal strength. Thus, the repeaters 12d and 12e are each at a position out of reach of a radio signal transmitted from the master 11 but are each at a position where they can each receive a radio signal transmitted from the repeater 12c. Therefore, the times of the repeaters 12d and 12e can be synchronized with the time of the master 11 via the repeater 12c.

Further, the synchronization of each of the repeaters 12d and 12e is performed based on level “2” time data, and thus, the relevant level holding part 112 holds level “3.” Each of the repeaters 12d and 12e picks one empty time slot and then transmits time data. For instance, the repeater 12d transmits level “3” time data, using a fifth time slot, and the repeater 12e transmits level “3” time data, using a sixth time slot.

The repeater 12f identifies a sixth time slot as a result of the signal search process and receives time data transmitted from the repeater 12e. As a result, the time of the repeater 12f is synchronized with the time of the repeater 12e. Thus, the time of the repeater 12f is synchronized with the time of the master 11 via the repeaters 12e and 12c. Further, the synchronization of the repeater 12f is performed based on level “3” time data, and thus, the level holding part 112 holds level “4.” The repeater 12f picks one empty time slot and then transmits level “4” time data.

As described above, in the present embodiment, all the units 10 (the master 11 and the repeaters 12), which constitute the clock system 1, operate in line with the above-described protocol, whereby the times of all the repeaters 12 are synchronized with the time of the master 11.

In an example of a system implemented based on the present embodiment, as a result of a measurement of a time delay between a master and a level “2” repeater, it was confirmed that the time delay was 5 msec on average and the standard deviation was 9.2 msec.

The present invention is not limited to the above embodiment and can be implemented in various forms without departing from the gist of the present invention. Therefore, the above embodiment is intended to be only illustrative in any aspect and should not be interpreted in a limited manner. For instance, the order in which the above-described processes (steps) are performed may be arbitrarily changed, or such processes (steps) may be performed in parallel, with no inconsistency arising in the content thereof.

What is claimed is:

1. A unit comprising:
a receiver which receives a radio signal;
a clocking unit which clocks a time;
a time correcting part which acquires, from the radio signal received by the receiver, time data including information on a time, and corrects a time of the clocking unit based on time information included in the time data;
a display unit for displaying a time of the clocking unit; and
a transmitter which transmits time data including information on a time clocked by the clocking unit and including a level that indicates how many units the obtained time has passed through.

2. The unit according to claim 1, further comprising a level holding part which holds, as a level of the unit, a level obtained by adding 1 to a level included in time data that has been taken out of the radio signal received by the receiver,
wherein a level included in time data transmitted by the transmitter is based on a level held by the level holding part.

3. The unit according to claim 1, wherein, when a plurality of time data is taken out of a plurality of radio signals, the receiver identifies a time slot which involves a minimum level included in time data, and when there is a plurality of time data each having a minimum level, identifies a time slot which involves a signal having a strongest strength with regard to the plurality of data, and wherein the time correcting part corrects a time of the clocking unit based on time data acquired from the identified time slot.

4. The unit according to claim 1, wherein the transmitter examines a radio signal received by the receiver so as to pick an empty time slot and transmits the time data using the picked empty time slot.

5. A clock system comprising a plurality of units, each of the plurality of units being configured by the unit according to claim 1.

6. The clock system according to claim 5, wherein at least one of the plurality of units operates as a master, and wherein the master acquires information on a current time from outside of the clock system and corrects a time of the clocking unit.

7. A method of synchronizing times of a plurality of units included in a clock system, each of the plurality of units executing:
receiving a radio signal;
acquiring, from the received radio signal, time data including information on a time, and correcting a time of a clocking unit based on time information included in the time data;
displaying a time of the clocking unit; and
transmitting time data including information on a time clocked by the clocking unit and including a level that indicates how many units the obtained time has passed through.
